(19) United States
(12) Patent Application Publication
(10) Pub. No.: US 2011/0058324 A1
(43) Pub. Date: Mar. 10, 2011

(54) I/O SHIELD STRUCTURE AND MOTHERBOARD MODULE THEREOF

(76) Inventors: Pai ching Huang, Taipei (TW); Meng Hsiung Lee, Taipei (TW)

(21) Appl. No.: 12/835,878

(22) Filed: Jul. 14, 2010

Related U.S. Application Data
(60) Provisional application No. 61/240,718, filed on Sep. 9, 2009.

(51) Int. Cl. G06F 1/16

(52) U.S. Cl. 361/679.4

(57) ABSTRACT

The invention discloses an I/O shield structure and a motherboard module thereof. The I/O shield structure includes a cover and a shield. The cover is fixed at and covers the I/O connecting portion of the motherboard, and the shield is fixed at the cover to expose the I/O connecting portion from the corresponding opening. The motherboard is fixed at the casing with the I/O connecting portion facing the assembly window of the casing, and the shield contacts the casing. Conductors are disposed at the two surfaces of the shield to make the I/O connecting portion, the cover and the shield electrically communicate with the casing to achieve over EMI suppression and ESD prevention. Furthermore, since the shield only contacts the casing and is unfixed to the casing, the assembly interference is avoided.

### BACKGROUND OF THE INVENTION

1. Field of Invention

The invention relates to an input/output (I/O) shield structure and, more particularly, to an I/O shield structure which only contacts a casing and is unfixed at the casing to avoid the assembly interference.

2. Related Art

A motherboard of a common computer system is fixed on a casing, and the casing has an assembly window corresponding to the I/O connecting portion of the motherboard to expose the I/O connecting portion. Thus, a user may insert various external devices such as a mouse, a keyboard and a USB device. Since the I/O connecting portion is fine, and the demand for the size is relatively high, the assembly window of the casing is rectangle, and an I/O shield made of a metal thin part is disposed at the assembly window additionally. The I/O shield has openings with different shapes cooperating with each connector of the I/O connecting portion to beautify the whole casing.

In assembling, the I/O shield is first fastened to the assembly window of the casing, and then the motherboard is disposed with the I/O connecting portion aiming the I/O shield to expose each connector. Afterward, the motherboard is locked to the casing via the screws. However, due to the tolerance in the manufacturing, the casing and I/O shield both have some size difference, and then the I/O connecting portion cannot aim the I/O shield accurately. Thus, some connectors are covered by the I/O shield and cannot be used by the user successfully.

In addition, due to the tolerance, great strength needs to be used to fasten the I/O shield. In addition, the I/O shield is usually a thin metal part, it easily cuts the hand of an assembler or is pushed out of the assembly window of the casing in assembling.

### SUMMARY OF THE INVENTION

The invention provides an I/O shield structure including a cover and shield. The cover is disposed at and covers an I/O connecting portion of the motherboard. The shield includes an opening corresponding to the I/O connecting portion. Overall electromagnetic interference (EMI) suppression and electrostatic discharge (ESD) prevention may be achieved by fixing the shield at the cover.

The invention also provides a motherboard module with an I/O shield structure including a motherboard, a cover and a shield. The motherboard has an I/O connecting portion, and the cover is disposed at and covers the I/O connecting portion of the motherboard. The shield has an opening corresponding to the I/O connecting portion, a first surface and a second surface opposite to the first surface. At least a first conductor is disposed at the periphery of the second surface to be fixed at the cover via the shield. The motherboard is disposed with the I/O connecting portion facing the assembly window of the casing. The shield and the I/O connecting portion electrically communicate to the casing by making the first conductor contact the periphery of the assembly window to improve the effect of suppressing the EMI. Furthermore, since the shield is fixed at the motherboard and only contacts the casing, even tolerance exists between the casing, the shield and the motherboard, the assembly interference does not exist.

These and other features, aspects and advantages of the present invention will become better understood with regard to the following description, appended claims, and accompanying drawings.

### BRIEF DESCRIPTION OF THE DRAWINGS

FIG. 1 is an exploded diagram showing the I/O shield structure and the motherboard module thereof according to an embodiment of the invention;

FIG. 2 is an assembly diagram showing the I/O shield structure and the motherboard module thereof according to an embodiment of the invention;

FIG. 3 is an assembly diagram showing the I/O shield structure and the motherboard module are assembled to the casing according to an embodiment of the invention;

FIG. 4 is a sectional diagram showing that the I/O shield structure and the motherboard module are assembled to the casing according to the embodiment of the invention; and

FIG. 5 is a schematic diagram showing the I/O shield structure and the motherboard module thereof according to another embodiment of the invention.

### DETAILED DESCRIPTION OF THE INVENTION

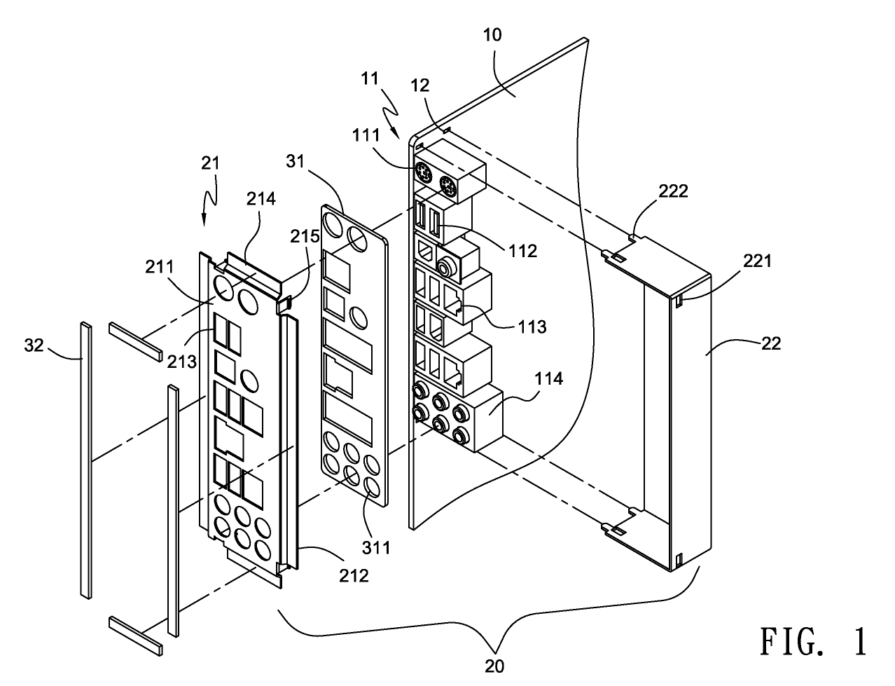

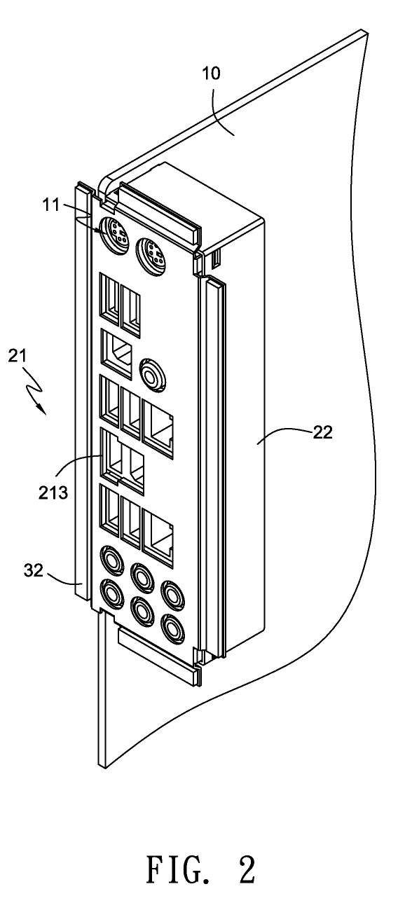

FIG. 1 is an exploded diagram showing the I/O shield structure and the motherboard module thereof according to an embodiment of the invention, and FIG. 2 is an assembly diagram showing the I/O shield structure and the motherboard module thereof according to an embodiment of the invention.

The motherboard module includes a motherboard 10 and an I/O shield structure 20. The motherboard 10 is substantially a plate, and at least an I/O connecting portion 11 is disposed thereon. The I/O connecting portion 11 is composed of at least a connector. As shown in FIG. 1, the I/O connecting portion 11 includes various connectors such as a P/S2 connector for connecting a mouse or a keyboard 111, a USB connector 112, a network connector 113 and an audio connector 114. Since there are many different kinds of the connectors, and the motherboard 10 with a different specification has different connectors, the connectors shown in FIG. 1 are taken as example.

I/O shield structure 20 includes a shield 21 and the cover 22. The shield 21 is substantially laminate-shaped and has a first surface 212 and a second surface 211 opposite to the first surface 212, and the shield 21 has at least an opening 213 corresponding to a connector of the I/O connecting portion 11 to allow the connector of the I/O connecting portion 11 to be exposed.

A second conductor 31 is disposed at the first surface 212 of the shield 21, and assembly portions 214 extend from the periphery of the second surface 211. The first conductors 32 are disposed at the assembly portions 214. In the embodiment, the second conductor 31 and the first conductor 32 are in the form of the conductive foam, and the second conductor 31 also has at least one opening 311 corresponding to the connector of the I/O connecting portion 11 to expose the connectors of the I/O connecting portion 11. The second conductor 31 also may be realized by a plurality of conductive foam disposed at the first surface 212 of the shield 21.

The cover 22 is a conductive metal cover with an open bottom and an open surface adjacent to the bottom. At least an inserting portion 222 is disposed at the bottom and may be inserted into the corresponding assembly hole 12 to dispose the cover 22 at the I/O connecting portion 11 on the motherboard 10. After being assembled, the cover 22 covers the I/O connecting portion 11, and space at one side of the connector is open (as shown in the left of FIG. 1). The mode of fixing the cover 22 to the motherboard 10 may be soldering with the I/O connecting portion 11 by cooperating the inserting portion 222 with the assembly hole 12. The cover 22 may be fixed in other modes such as tight fit, locking, fastening or holding.

The first surface 212 of the shield 21 is connected to the cover 22 to make the connector of the I/O connecting portion 11 exposed from the opening 213 of the shield 21, and the other part of the I/O connecting portion 11 is covered by the cover 22 and the shield 21 to suppress electromagnetic interference (EMI) overall. The shield 21 may be fixed to the cover via the hook 215 and the fixing hole 221 as shown in FIG. 1, and it also may be fixed in other modes such as adhering or locking.

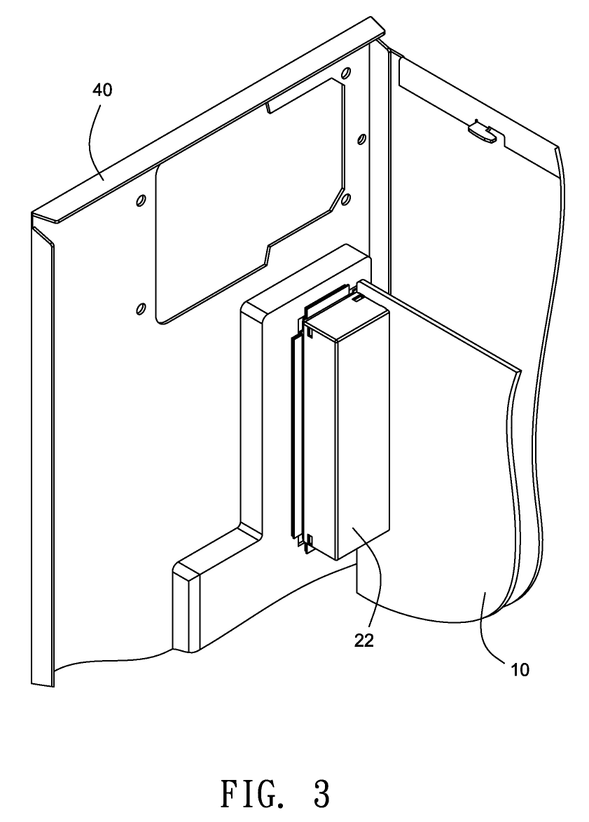

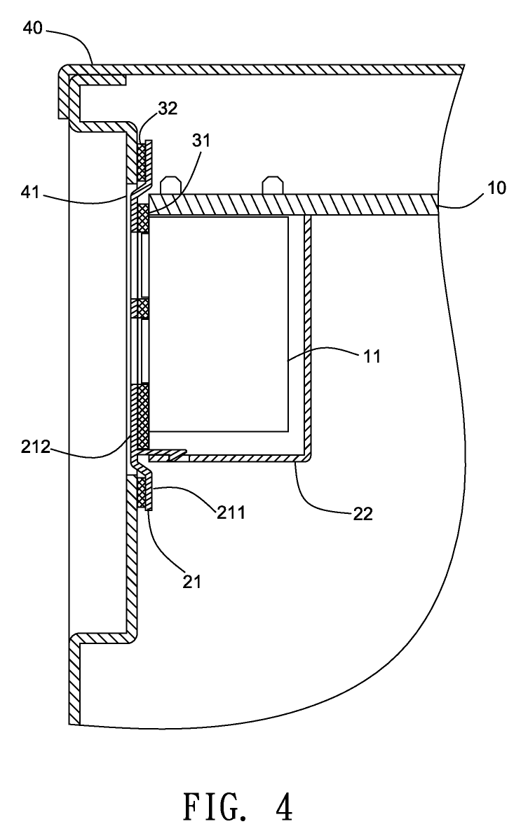

FIG. 3 is an assembly diagram showing that the I/O shield structure and the motherboard module are assembled to the casing. FIG. 4 is a sectional diagram showing the I/O shield structure and the motherboard module are assembled to the casing.

When being assembled to the casing 40, the shield 21 and the I/O connecting portion 11 face the assembly window 41 to allow shield 21 to contact the periphery of the assembly window 41 via the first conductors 32 on the peripheral assembly portions 214. Then, the motherboard 10 is fixed to the casing 40, and it is usually fixed via screws, which is not the characteristic of the invention and is the conventional technology. Therefore, the mode of fixing the motherboard is not described herein for a concise purpose.

After assembled, the cover 22, the I/O connecting portion 11, the shield 21 and the casing 40 electrically communicate to each other via the second conductor 31 and the first conductor 32. Thus, not only the electromagnetic interference (EMI) is suppressed, and the electrostatic discharge (ESD) is prevented. To achieve the objective, besides the second conductor 31 and the first conductor 32, the cover 22 and the shield 21 are also made of conductive material which usually is metal.

Since the shield 21 only contacts the casing and is unfixed at the casing 40, the assembly tolerance between the casing 40, the shield 21 and the motherboard 10 may be eliminated via the tolerance provided by the contacting and unfixing assembly mode. Thus, the assembly interference does not exist. In other words, as shown in FIG. 4, the interference in the left and right direction is absorbed via the elasticity of the second conductor 31 and the first conductor 32, and the interference in the up and down direction is absorbed via the first conductor 32 which only contacts the casing 40 and is unfixed to the casing 40. Thus, the assembly interference is avoided.

If the shield 22 and the cover 21 are not made of conductive material, a conductive structure may be disposed around the I/O connecting portion 11 to connect the ground, and then the same effect of providing tolerance in the assembly mode is achieved.

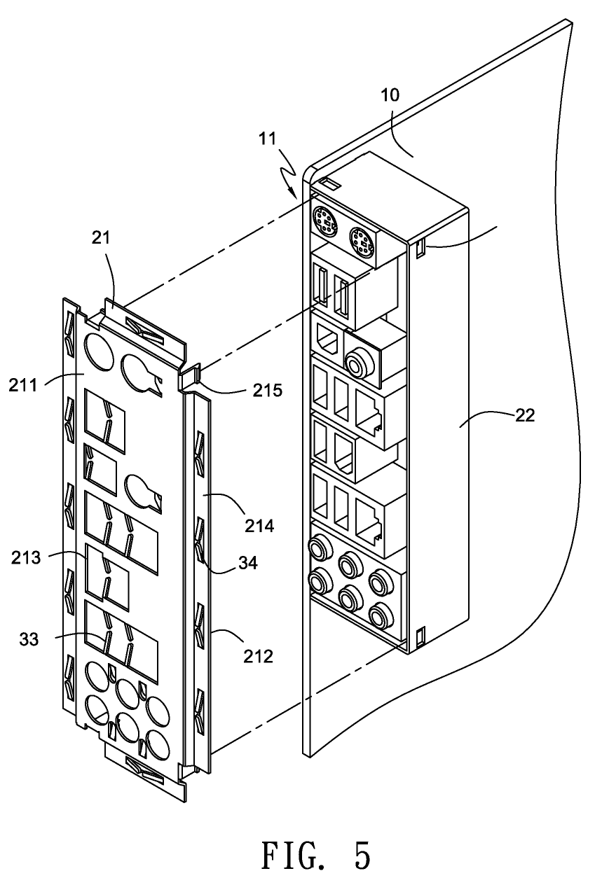

FIG. 5 is a schematic diagram showing the I/O shield structure and the conductor of the motherboard module according to another embodiment of the invention.

Besides the conductive foam, the second conductor 31 and the first conductor 32 also may be in the form of common metal elastic sheets. In other words, second metal elastic sheets 34 are disposed on the assembly portion 214 of the shield 21 and protrude toward the second surface 211. First metal elastic sheets 33 are disposed adjacent to the opening 213 and protrude toward the first surface 212. Thus, the same effect is achieved.

Thus, in the I/O shield structure and the motherboard module thereof provided in the invention, the shield is designed to be fixed on the motherboard via the cover instead of being fixed on the casing as the conventional technology. Therefore, not only the assembly is more convenient, and the assembly interference generated by the tolerance is avoided. Cooperating with the design of the cover, the shield and the conductor, the over EMI suppression and the ESD prevention are achieved.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An I/O shield structure, adapted for a motherboard having an I/O connecting portion, the I/O shield structure comprising:
a cover disposed at the I/O connecting portion; and
a shield having an opening corresponding to the I/O connecting portion and fixed at the cover, wherein the I/O connecting portion is covered via the cover and the shield.

2. The I/O shield structure according to claim 1, wherein the cover is made of metal.

3. The I/O shield structure according to claim 1, wherein a conductor is further disposed at a surface of the shield, and the conductor contacts the I/O connecting portion to electrically communicate with the shield and the cover.

4. The shield structure according to claim 3, wherein the conductor is conductive foam.

5. The shield structure according to claim 3, wherein the conductor is a metal elastic sheet.

6. The I/O shield structure according to claim 1, wherein a conductor is disposed at the periphery of the shield to contact an assembly window of a casing to make the shield and the I/O connecting portion electrically conduct with the casing.

7. The I/O shield structure according to claim 6, wherein the conductor is conductive foam or a metal elastic sheet.

8. The I/O shield structure according to claim 1, wherein the cover is inserted in the motherboard to be fixed at the motherboard.

9. The I/O shield structure according to claim 1, wherein the shield is fixed at the cover by fastening, adhering or locking.

10. A motherboard module having an I/O shield structure, assembled to a casing having an assembly window, the motherboard module comprising:
a motherboard having an I/O connecting portion;
a cover disposed at and covering the I/O connecting portion; and
a shield having an opening corresponding to the I/O connecting portion and fixed at the cover, wherein a first conductor is disposed at the periphery of the shield to dispose the I/O connecting portion at the assembly window and make the I/O connecting portion contact the assembly window to make the shield and the I/O connecting portion electrically communicate with the casing.

11. The motherboard module with the I/O shield structure according to claim 10, wherein the cover is made of the metal.

12. The motherboard module with the I/O shield structure according to claim 10, wherein the first conductor is conductive foam, a metal elastic sheet or the combination thereof.

13. The motherboard module with the I/O shield structure according to claim 10, wherein the cover is inserted at the motherboard to be fixed at the motherboard.

14. The motherboard module with the I/O shield structure according to claim 10, wherein the shield is fixed at the cover by fastening, adhering or locking.

15. The motherboard module with the I/O shield structure according to claim 14, wherein the shield has a hook to be fixed at a corresponding fixing hole of the cover.

16. The motherboard module with the I/O shield structure according to claim 10, wherein the shield only contacts the casing and is unfixed at the casing to provide a tolerance of making the I/O connecting portion of the motherboard correspond to the assembly window.

17. The motherboard module with an I/O shield structure according to claim 10, wherein a second conductor is disposed at a surface of the shield, and the second conductor contacts the I/O connecting portion to electrically communicate with the shield and the cover.

18. The motherboard module with the I/O shield structure according to claim 10, wherein the second conductor is conductive foam, a metal elastic element or the combination thereof.
